(19) United States
(12) Patent Application Publication
(10) Pub. No.: US 2013/0005351 A1
(43) Pub. Date: Jan. 3, 2013

(54) METHOD AND SYSTEM FOR BROADCASTING THE LOCATION OF A DEVICE

(75) Inventors: Michael Burns, Middletown, NJ (US); Xerxes Kotval, Matawan, NJ (US); Peter Schott, Howell, NJ (US)

(73) Assignee: ALCATEL-LUCENT USA INC., Murray Hill, NJ (US)

(21) Appl. No.: 13/173,508

(22) Filed: Jun. 30, 2011

(51) Int. Cl. H04W 24/00

(52) U.S. Cl. 455/456.1

(57) ABSTRACT

The method includes sending geolocation data of the device to a server, receiving, by the device from the server, a list of venues whose boundaries contain the geolocation data, selecting, on the device, a plurality of venues selected from the list, and sending the plurality of venues to a communication platform for broadcasting thereon. Sending venues to the communication platform may be associated with a privacy setting for each venue, thereby permitting a different venue to be seen by a chosen subset of users.

### FIELD

The present invention concerns a method and a system for broadcasting the location of a device or user, in particular on communication platforms, also known as “social networks”.

### RELATED ART

This section introduces aspects that may be helpful in facilitating a better understanding of the invention. Accordingly, the statements of this section are to be read in this light and are not to be understood as admissions about what is in the prior art or what is not in the prior art.

Existing services for broadcasting location are known, for example Foursquare™, registered to Foursquare Labs, Inc, Facebook Places™, registered to Facebook, Inc, etc. These services leverage geolocation services to identify the location of the user through his portable device, often a mobile phone.

The term broadcasting is commonly referred to as “checking in” to a place, or a venue. The term “venue” is commonly used to refer to a geographic area of interest that the user can check into. It may be as small as a room or arbitrarily large such as an entire state. These services allow users to broadcast to their friends which venue they are currently located, or were located when they used the checking-in service. Some services allow for the users to customize which venue information to broadcast, while other services do not allow this customization.

A difficulty of using these services or systems, is that the user should pick which venue information is the most relevant to the greatest number of his peers on the social network.

Example embodiments provide an alternative solution.

### SUMMARY OF THE INVENTION

Example embodiments provide a method for broadcasting the location of a device on a communication platform, the device being configured to communicate with a server including venue location data. The method includes sending, by the device, geolocation data of the device to the server. Receiving, by the device from the server, a list of venues whose boundaries include the geolocation data. Selecting, on the device, a plurality of venues selected from the list. And, sending said plurality of venues to a communication platform for broadcasting thereon.

Another example embodiment includes a venue distribution system. The venue distribution system includes a storage device for storing a plurality of location coordinate data and corresponding venue information and a communication device adapted for receiving location coordinate data of a user, and for returning to said user a plurality of venues whose pre-defined boundaries contain said location coordinate data.

Another example embodiment includes a portable device. The portable device includes a geolocation device, configured to obtain location coordinate data, a user interface service configured to interact with a user and a communication module configured to communicate with a communication platform. The portable device is configured to poll a storage device comprising location coordinate data and corresponding venue information, and send simultaneously a plurality of said corresponding venue information to a communication platform via the communication module.

Another example embodiment includes a computer program configured to execute the aforementioned method.

According to example embodiments a user of the portable device may simultaneously broadcast different venue information to different people, thus increasing the probability that someone will find the venue information useful, increasing the interest of others in the whereabouts of the user in question. Some embodiments also allow the user to selectively control privacy levels so that different degrees of location precision are disclosed to different peers.

### BRIEF DESCRIPTION OF THE DRAWINGS

Some embodiments of devices and methods in accordance with embodiments of the present invention are now described, by way of example only, and with reference to the accompanying drawings, in which:

FIG. 1 schematically illustrates an example embodiment of a communication system;

FIG. 2 illustrates a mode of operating the example embodiment of FIG. 1;

FIG. 3 schematically illustrates an example embodiment of a location coordinate corresponding to various venues;

FIG. 4 schematically illustrates an example embodiment of a user interface situation;

FIG. 5 schematically illustrates another mode of operating the example embodiment of FIG. 1; and

FIGS. 6 and 7 illustrate schematically yet other example embodiments of a user interface situation.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures. Before discussing example embodiments in more detail, it is noted that some example embodiments are described as processes or methods depicted as flowcharts. Although the flowcharts describe the operations as sequential processes, many of the operations may be performed in parallel, concurrently or simultaneously.

In addition, the order of operations may be re-arranged. The processes may be terminated when their operations are completed, but may also have additional steps not included in the figure. The processes may correspond to methods, functions, procedures, subroutines, subprograms, etc. Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium. A processor(s) will perform the necessary tasks. Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and will be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

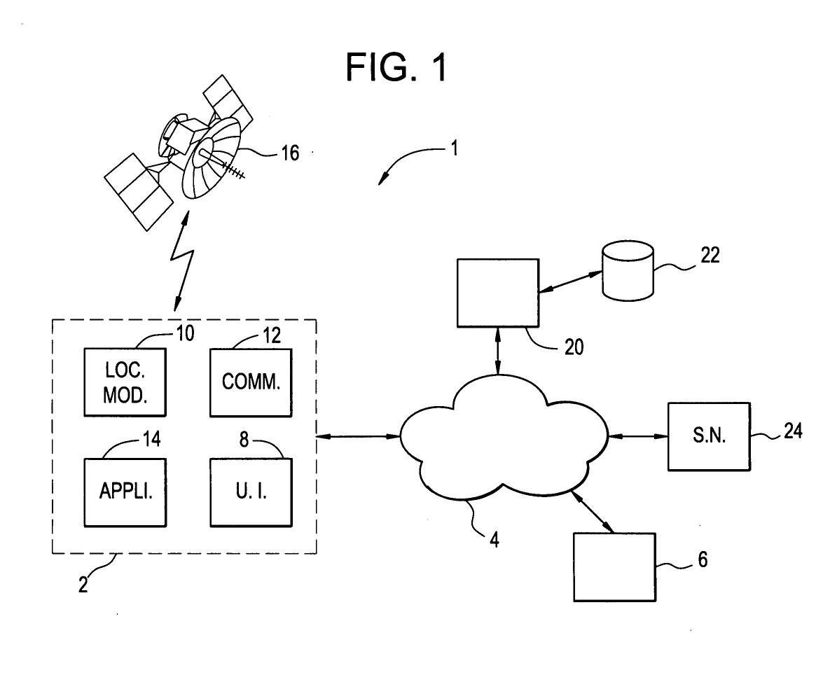

An example embodiment of a communication system is illustrated schematically on FIG. 1. The system 1 includes a mobile device 2, a broadcasting system 6 and a client geolocation management server 20. The mobile device 2 may be configured to communicate wirelessly with a communication network 4. The broadcasting system 6 may be configured to communicate with the mobile device 2 via the communication network 4. The client geolocation management server 20 may be configured to communicate with the mobile device 2 via the communication network 4.

The communication network 4 may be a private or public communication network. For example, the communication network 4 may be the internet. The communication network 4 may be configured to enable or leverage various other communication services, like Foursquare™, or Facebook Places™, which a user may interact with from a mobile device (e.g., mobile device 2) in communication with the internet.

The mobile device 2 may be, for example, a mobile phone, a laptop computer, or a tablet device adapted to access the internet or other communication network 4, etc. The mobile device 2 may include a User Interface 8, a localization module 10, a wireless communication module 12, and a user application space 14. The user interface 8 may include at least a screen for a user to view information and input means such as a keyboard for entering in data.

The localization module 10 may be configured to determine the location of the mobile device 2. The localization module 10 may, for example, include a GPS apparatus configured to communicate with Global Positioning System (GPS) satellites 16 or the like. Alternatively and/or in addition to, the localization module 10 may communicate with pseudolites or the like. The localization module 10 may be controlled via an application software or hardware in the user application space 14 of the mobile device 2. The wireless communication module 12 may be configured to communicate with the communication network 4 over an air interface, although example embodiments are not limited to wireless communication, and also applies to wireline communication networks. The wireless communication module 12 may, for example, be configured to operate using one or more of the following protocols: Wifi, GSM, CDMA, Bluetooth, etc.

The client geolocation management server 20 may be configured to receive, via the communication network 4, geolocation information indicative of the position of a GPS receiver or user, and is further adapted to return, via the communication network 4, venue information corresponding to said geolocation information.

For example, the client geolocation management server 20 may be associated with a storage device 22 (e.g., a database device) that includes a list of venues, and for each venue an indication of localization (e.g., longitude/latitude coordinates), and size (e.g., radius information). According to at least one example embodiment, each venue may be associated with a customized shape and size to more accurately represent the venue, for example a polygon representation by way of a plurality of vertices.

The database may contain different named venue objects with different levels of granularity for the same geolocation point. For example, a given geolocation coordinate may correspond to a business venue, a street venue, a suburb venue, a city venue, and a state venue in the database, all of which may contain that particular geolocation coordinate.

The storage device 22 may be embedded within the client geolocation management server 20, or alternatively, could the storage device 22 may be physically remote or even distributed around a network (e.g., distributed around the communication network 4). In at least one example embodiment, the storage device 22 may be local to the mobile device 2. The broadcasting system 6 may be configured to receive localization information from the mobile device 2 and may be configured to broadcast the localization information on a particular communication platform 24, for example a “social network” platform (e.g., Facebook™, Foursquare™, etc.).

As such, the broadcasting system 6 may be configured to manage the settings to one or more communication platforms 24, and may be configured to post, reformat or adapt the data, as necessary, to the user's selected venue information to one or more communication platforms 24. For example, the communication platform 24 may be configured to post a plurality of localization information for an individual user simultaneously. For example, the communication platform 24 may be configured to post a same geolocation coordinate but with different degrees of precision.

In at least one example embodiment, the communication platform 24 may be configured to broadcast a desired (or, alternatively, a predetermined) localization information to selective addressees. For example, the mobile device 2 may associate a particular privacy policy, or broadcast policy, for each localization broadcasting operation, such that a particular localization information broadcast may only be visible to certain addressees. The selection of privacy groups or individuals may depend on the communication platform 24 onto which the localization information is broadcast, and may be managed by the broadcasting system 6.

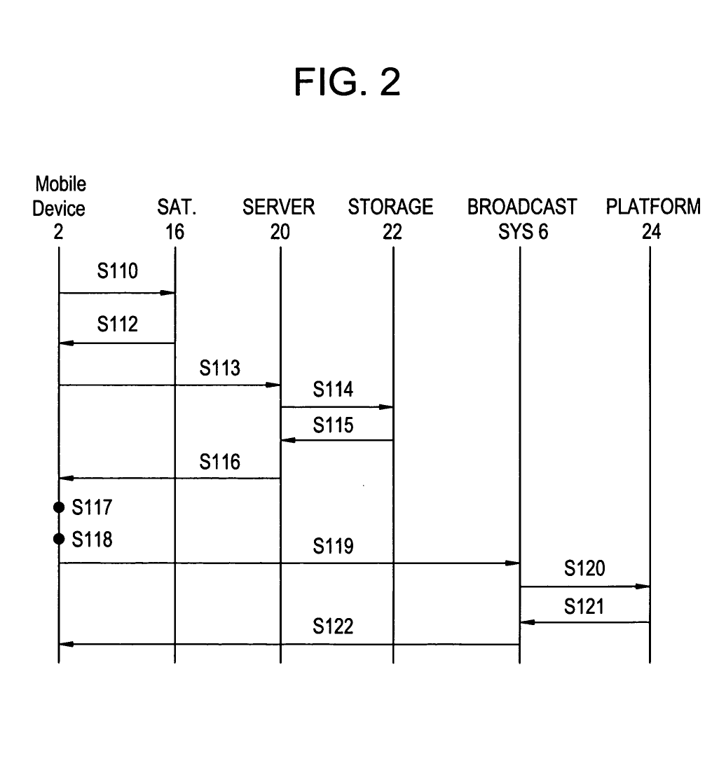

The following operation of the example embodiments of FIG. 1 will be illustrated in conjunction with FIG. 2. Referring to FIG. 2, in step S110 the user, on his or her mobile device 2, uses the localization module 10 to poll, for example, the GPS satellites 16 to obtain the current latitude/longitude coordinates (lat/long coordinates) of the localization module 10. In step S112, the GPS satellites then return the user's current lat/long coordinates, for example to the controlling application of the Localization module 10.

In step S113, an application (e.g., in the user application space 14 of the mobile device 2) sends the lat/long coordinates obtained by the Localization module 10 to the geolocation management server 20 for processing. In step S114, the client geolocation management server 20 queries associated storage device 22 for predefined venues whose pre-defined boundaries contain the lat/long coordinates.

In step S115, the storage device 22 returns the corresponding venues to the client geolocation management server 20. The corresponding venues will correspond to the lat/long coordinates according to various degrees of precision, depending on the boundaries of the venue that have been pre-defined. These boundaries may be pre-defined by some radius around the geolocation coordinates, either manually or automatically by the geolocation management server 20.

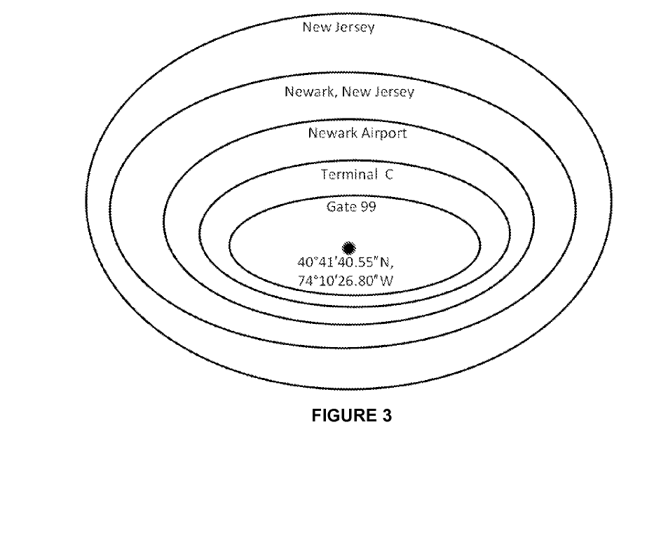

Alternatively and/or in addition to, the boundaries may be defined by the vertices of some polygon that has previously been manually placed around the geolocation coordinates by this user or by other users through use of the geolocation management server 20. For example, if the lat/long coordinates sent by the user device at step S113 were 40°41′40.55″N, 74°10′26.80″W, the storage database 22 may return the following venues, as illustrated at FIG. 3, Gate 99; Terminal C; Newark Airport; Newark, N.J.; and New Jersey. In step S116, the client geolocation management server 20 returns the matching polled venues to the mobile device 2.

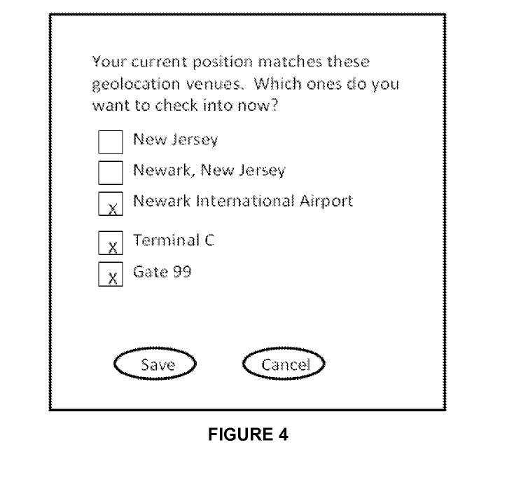

In step S117, the user interface 8 and the associated application of the user application space 14 of the mobile device 2 prompts the user for which of the matching geolocation venues he or she wants to broadcast, or “check into”. In step S118, the user, via the user interface 8 of the mobile device 2, selects which of the matching geolocation venues he or she wishes to broadcast on the communication platform 24. See, for example, the non-limiting example embodiment illustrated in FIG. 4. The broadcast of geolocation presence or venues is sometimes referred to as “checking in” on certain communication platforms or social network platforms 24.

In step S119, the venue choices (as selected by the user of the mobile device 2) are sent to the broadcasting system 6 for, for example, preparation, adaptation, and formatting. In step S120, the broadcasting system 6 sends the formatted choices to the appropriate communication platform 24. In step S121, the communication platform 24 confirms the correct broadcast of venues, and the broadcasting system 6 in turn confirms the success of the operation to the mobile device 2.

It is to be noted that the mobile device 2 may be preconfigured with the required user names and passwords and applications, if required, to access, communicate, and broadcast information on the communication platform 24. The broadcasting system 6 may receive this identification information from the mobile device 2, and/or may have a locally stored copy.

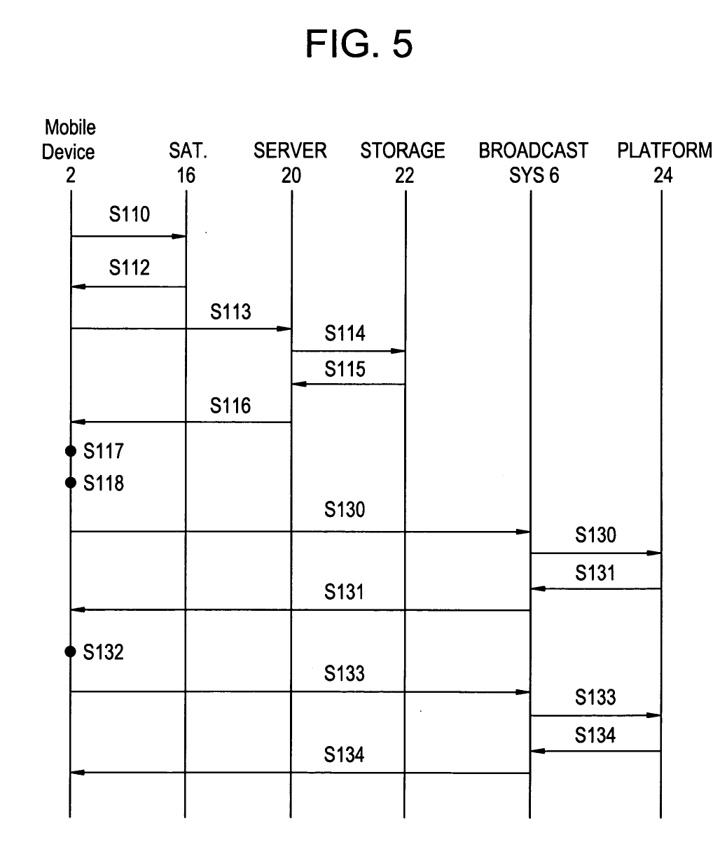

FIG. 5 illustrates another mode of operating the example embodiments of FIG. 1. In the example embodiment illustrated by FIG. 5, the user of the mobile device 2 may expose differing levels of specificity about the user's location broadcasts, or check-ins, to third party users. In other words, the user will set different privacy levels, or broadcasting rights, of selected matching venues to different predefined groups of third parties of the communication platform 24. For example, the communication platform 24 may already have set up two different groups of users on the communication platform 24: one group being “Friends & Family” and the other group being “Merchants”. In this mode of operation, according to example embodiments, the user may let the user's “Friends & Family” group know that the user is checked into Gate 99, and let the “Merchants” group know that she is checked into Terminal C.

Following this operation, nearby friends may direct themselves to Gate 99, and Merchants in Terminal C may contact the user with, for example, discount offers in Terminal C.

Returning to FIG. 5, a user may perform steps S110 to S118 as described above with regard to FIG. 2. In other words, the user may poll the satellites for geocoordinate information (S110), then query the client geolocation management server 20 and its associated storage means 22 for predefined venues associated with the corresponding lat/long coordinates (S113 and S114), before selecting which venues to broadcast on the communication platform 24 (S117 and S118). According to the present example embodiment, in step S130, the user queries the communication platform 24 for the identities of existing groups of users.

In step S131, the communication platform 24 returns to the mobile device 2 the existing and predefined groups registered on the mobile device's 2 account on the communication platform 24. The predefined groups of users may, for example, be “Friends & Family” and/or “Merchants”, etc. Alternatively or in addition, the communication platform may return the individual names of peers (commonly called “friends”) of the user.

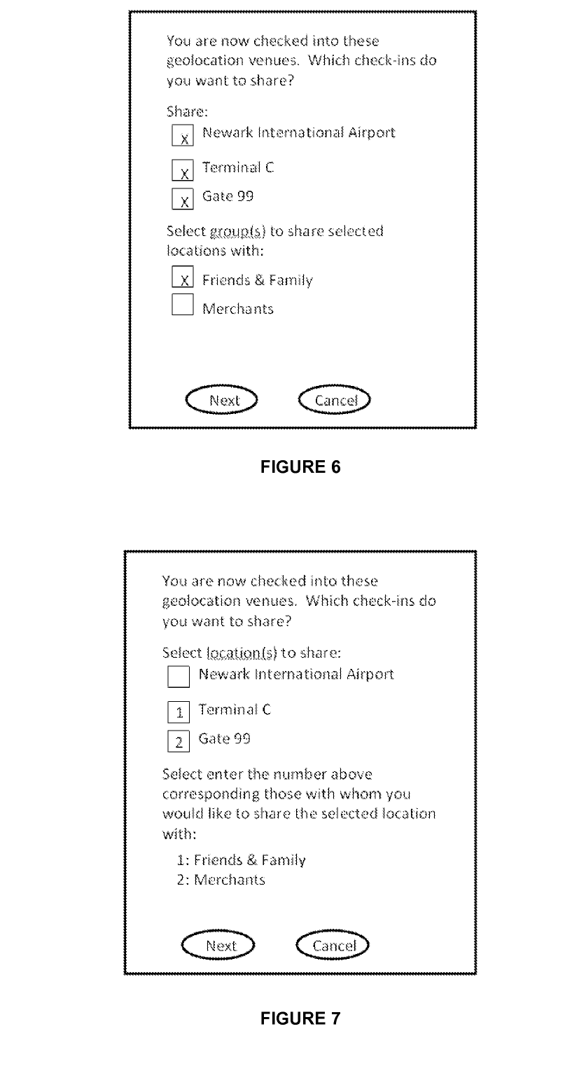

In step 132, via the user interface 8 in portable device 2, the user pairs matched venues to broadcast with user groups or individual users to broadcast to. For example, as illustrated at FIG. 6, the user interface 8 may present two graphical windows, one window showing the preselected venues to broadcast (selected in step S118), and a second window a list of the groups received in step S131 for broadcasting to.

Alternatively or in addition, as illustrated schematically by FIG. 7, the user interface 8 may present a list of the preselected venues to broadcast (selected in step S118), along with the space to match each selected venue to a reference number ‘1’, ‘2’, etc. referencing each group of users on the communication platform 24. In step S133, upon selection by the user of the mobile device 2 of the venues to be broadcast, and to which groups of people, these choices are sent to the communication platform 24 for broadcasting. In step S134, the communication platform 24 confirms the correct broadcast of venues.

As with the previous described example embodiments, it is to be noted that the mobile device 2 may be preconfigured with the required user names and passwords and applications, if required, to access, communicate, and broadcast information on the communication platform 24. The broadcasting system 6 can receive this identification information from the mobile device 2, or may have a locally stored copy.

In at least one example embodiment, the same functionalities may be accomplished by integrating the client geolocation management server 20 and the associated storage device 22 into the mobile device 2. In at least one example embodiment, a database from such an integrated storage device 22 may be regularly updated with new information from the communication network 4. Furthermore, although the foregoing specification described embodiments wherein the broadcasting system 6 is delocalized in a communication network, one skilled in the art will recognize the functionalities may readily be implemented inside the mobile device 2.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

While example embodiments have been particularly shown and described, it will be understood by one of ordinary skill in the art that variations in form and detail may be made therein without departing from the spirit and scope of the claims.

The present inventions may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

1. A method for broadcasting the location of a device on a communication platform, the device being configured to communicate with a server including venue location data, the method comprising:
sending, by the device, geolocation data of the device to the server;
receiving, by the device from the server, a list of venues whose boundaries contain said geolocation data;
selecting, on the device, a plurality of venues from the list;
selecting, on the device, a privacy setting for each selected venue to permit each selected venue to be seen by a chosen subset of users on the communication platform; and
sending the plurality of venues to a communication platform for broadcasting in accordance with said selected privacy settings.

2. (canceled)

3. A method for broadcasting according to claim 1, wherein each venue is defined by a location data and an associated boundary around the location data.

4. A method for broadcasting according to claim 1, wherein each venue corresponds to a 2D surface, the 2D surface being defined by a polygon.

5. A method for broadcasting according to claim 1, wherein a venue corresponds to a vertical delimitation of space defined by a 3D shape encompassing all points within the 3D volume defined by the shape.

6. A method for broadcasting according to claim 5, wherein the vertical delimitation of space is one or more floors in a building.

7. A method for broadcasting according to claim 1, wherein said communication platform is a social network platform.

8. A venue distribution system, comprising:
a storage device configured to store a plurality of location coordinate data and corresponding venue information;
a communication device configured to receive location coordinate data of a user, and configured to return, to said user, a plurality of venues whose pre-defined boundaries include said location coordinate data, and said communication device configured to broadcast at least one of the plurality of venues on a communication platform; and
a user interface associated with the communication device configured to receive, from said user, a selected venue and a selected privacy setting to be associated with said selected venue, each selected privacy setting being used to permit each selected venue to be seen by a chosen subset of users on the communication platform.

9. The venue distribution system according to claim 8, wherein the storage device includes polygon surface definitions of at least a subset of venues stored therein.

10. A portable device comprising:
a geolocation device configured to obtain location coordinate data;
a user interface service configured to interact with a user; and
a communication module configured to communicate with a communication platform, wherein the portable device is configured to,
poll a storage device including location coordinate data and corresponding venue information, and
send simultaneously a plurality of the corresponding venue information to a communication platform via the communication module, each of the corresponding venue information sent to the communication platform is associated with a privacy indication, such that different venues are seen by a chosen subset of users on the communication platform.

11. (canceled)

12. The portable device according to claim 10, wherein the privacy indication are set by a user via the user interface device.

13. The portable device according to claim 10, wherein the storage device is remote from the portable device and is polled remotely via the communication module.

14. A non-transitory computer readable medium including a data structure storing computer-executable code that, when executed on a computer processor, causes the computer processor to perform the method of claim 1.
